(19) United States
(12) Patent Application Publication
(10) Pub. No.: US 2009/0176190 A1
(43) Pub. Date: Jul. 9, 2009

(54) SCREW ANCHORED ORTHODONTIC APPLIANCE AND METHODS

(75) Inventors: Albert Ruiz-Vela, Alta Loma, CA (US); William W. Wood, Pasadena, CA (US); Pinki Ghantiwala, Walnut, CA (US); Jason A. Mohr, Fontana, CA (US); John C. Fuller, Racine, WI (US); Kevin S. Corcoran, Corona, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/349,284

(22) Filed: Jan. 6, 2009

Related U.S. Application Data
(60) Provisional application No. 61/019,388, filed on Jan. 7, 2008.

(51) Int. Cl. A61C 8/00

(52) U.S. Cl. 433/174; 433/215

(57) ABSTRACT

An orthodontic appliance for correcting malocclusions including a device having first and second operating components, at least one of the operating components configured to be coupled to at least one tooth of a patient. The operating components are coupled together in a manner allowing controlled movement of at least one of the operating components for purposes of correcting the malocclusion. A connector element includes an eyelet coupled to at least one of the first or second operating components, and an orthodontic screw includes a threaded portion and a head. The connector element may be removed from the screw while the threaded portion remains implanted in skeletal structure of a patient.

This application claims the priority of U.S. Provisional Patent Application Ser. No. 61/019,388, filed on Jan. 7, 2008 (pending), the disclosure of which is incorporated by reference herein.

### TECHNICAL FIELD

The present invention generally relates to orthodontic appliances for correcting malocclusions and, more specifically, orthodontic appliances configured to be anchored using screw implants.

### BACKGROUND

There are currently several different types of orthodontic appliances that are designed to correct malocclusions in patients. One primary challenge of these appliances relates to the fact that most are designed to be attached to the patient's teeth. Therefore, even if the clinician is attempting to correct the malocclusion by using a “skeletal” correction, such as a palatal expansion, one or more teeth may be unintentionally displaced relative to the skeletal structure during the process. In other cases, the clinician may desire to correct the malocclusion by moving one or more specific teeth, such as in a molar distalization procedure, and unintentionally displace other teeth in the process.

As an attempt to overcome these challenges, orthodontists have recently started using mini-screws in conjunction with these appliances. The goal is to anchor the appliance and cause less unintended tooth movement. A disadvantage of this approach is that the orthodontist or clinician typically places the appliance first and then uses a mini-screw driven into the patient's skeletal structure or osseous tissue to secure the appliance in place. If the clinician needs to remove the appliance prior to completion of treatment, such as due to appliance breakage or the need for cleaning or adjustment, the clinician must first remove the mini-screw. However, when the appliance is then replaced in the patient, the original screw hole in the bone may be compromised and the screw may loosen. To overcome this problem, the clinician could use a new location for the screw but doing so would require relocating the screw hole or eyelet in the appliance as well.

### SUMMARY

The present invention generally provides an orthodontic appliance and method for attaching and removing the appliance in manners that address the challenges in this area. Generally, the orthodontic appliance may comprise a device including first and second operating components. At least one of the operating components is configured to be coupled to at least one tooth of a patient. The operating components are coupled together in a manner allowing controlled movement of at least one of the operating components for purposes of correcting the malocclusion. A connector element including an eyelet coupled to at least one of the first or second operating components is configured to be coupled with an orthodontic screw. The orthodontic screw is configured to be received by the eyelet and includes a threaded portion for implantation into the patient, and a screw head. The head is movable between a locked position and an unlocked position. This movement may be of the entire head or only one or more portions thereof. In the locked position the connector element is locked to the head and in the unlocked position the connector element may be removed from the head while the threaded portion remains implanted in skeletal structure of the patient.

The first and second operating components, for example, may form part of a palatal expansion device, a molar distalization device, or another orthodontic appliance for treating a malocclusion. The eyelet of the connector element and the head of the screw may have corresponding geometric shapes, such as triangular shapes or other polygonal shapes. In one embodiment, the head may be rotated from the locked position to the unlocked position. This rotation may occur together with rotation of the threaded portion or not. Another option is to have the head removable from the threaded portion. It will be appreciated that many different shapes for the eyelet and the screw head may be utilized and that the eyelet and screw head do not necessarily have to be corresponding in shape.

In another embodiment, an orthodontic appliance is provided for correcting malocclusions including a device with first and second operating components. At least one of the operating components is configured to be coupled to at least one tooth of a patient. The operating components are coupled together in a manner allowing controlled movement of at least one of the operating components for purposes of correcting the malocclusion. A connector element includes an eyelet coupled to at least one of the first or second operating components. At least a portion of the connector element is movable between locked and unlocked positions. An orthodontic screw includes a threaded portion and a head. The head is retained in the eyelet in the locked position and is removable from the eyelet in the unlocked position while the threaded portion remains implanted in skeletal structure of a patient. As with all embodiments, the first and second operating components may, for example, be part of a palatal expansion device or molar distalization device and the eyelet and the head may have corresponding geometric shapes, such as triangular shapes. In this embodiment, at least the portion of the connector element may be rotated from the locked position to the unlocked position or, for example, may be moved in a linear manner. A biasing structure may be provided in these embodiments, for example, to assist with retaining the locked and/or unlocked positions.

A method that is provided herein of attaching an orthodontic appliance to a patient, may comprise implanting a threaded portion of at least one orthodontic screw in skeletal structure of the patient. The orthodontic screw is retained with respect to an eyelet of the orthodontic appliance using a head of the orthodontic screw in a locked position relative to the eyelet. To then remove the orthodontic appliance, at least one of the head or the eyelet is moved from the locked position to an unlocked position. This allows the eyelet to be removed from the orthodontic screw while the threaded portion remains implanted in the skeletal structure of the patient. Other features of the method, and the various embodiments disclosed herein will become more apparent from a review of the description of the various embodiments and their method of implantation and removal.

### BRIEF DESCRIPTION OF THE DRAWINGS

FIG. 1 is a perspective view illustrating an appliance constructed in accordance with a first embodiment and connected with respect to the mouth and teeth of a patient.

FIGS. 1A, 1B and 1C are perspective views of a connector element and screw of the appliance shown in FIG. 1, with the screw successively moving between a locked position and an unlocked position suitable for removing the connector element or eyelet.

FIG. 2 is a perspective view of another embodiment of an appliance connected to the teeth and palate of a patient.

FIGS. 2A, 2B and 2C are perspective views of a screw and connector element or eyelet successively showing the screw in locked and unlocked positions, similar to FIGS. 1A, 1B and 1C.

FIG. 3A is a disassembled perspective view of another embodiment of a screw constructed to allow removal of an orthodontic appliance without removing the implanted screw.

FIG. 3B is a disassembled elevational view of the screw shown in FIG. 3A, and additionally showing a connector element of an orthodontic appliance.

FIGS. 3C and 3D are respective longitudinal cross sectional views of the screw and connector element shown in FIG. 3B and respectively showing locked and unlocked positions of the screw head relative to the threaded portion of the screw.

FIG. 4 is a perspective view of a connector element of an orthodontic appliance coupled with a screw in accordance with another embodiment.

FIG. 4A is a top view of the connector element and screw shown in FIG. 4 and schematically illustrating the movement of the eyelet or connector element between locked and unlocked positions.

FIG. 5A is a perspective view of an orthodontic screw with a head that is movable between locked and unlocked positions by way of biased or resilient compression.

FIG. 5B is a top view of the screw shown in FIG. 5A, but also showing a connector element mounted to the screw head.

FIG. 5C is a perspective view similar to FIG. 5A, but illustrating the application of a connector element associated with an orthodontic appliance.

FIG. 6 is a perspective view of another embodiment of an orthodontic screw in which the screw head is independently rotatable.

FIG. 6A is a perspective view of the screw shown in FIG. 6, and further illustrating removal of the head.

FIG. 6B is a perspective view of the orthodontic screw shown in FIG. 6A with the head removed.

FIG. 6C is a bottom view of the screw head showing the recesses used to register the six different angular or rotational positions of the screw head.

FIGS. 6D, 6E and 6F are similar to FIG. 6C, but successively illustrate rotation of the screw head with respect to the threaded portion of the screw between two of six different positions.

FIG. 7 is a perspective view of another embodiment illustrating an alternative connector element for releasably securing an orthodontic screw to an orthodontic appliance.

FIG. 7A is a top view of the connector element and screw shown in FIG. 7.

FIGS. 7B and 7C are cross sectional views illustrating the connector element in respective locked and unlocked positions relative to the screw head.

FIG. 8A is a perspective view showing an alternative embodiment of a connector element coupled with an orthodontic screw.

FIG. 8B is a perspective view of the connector element and orthodontic screw shown in FIG. 8A in longitudinal cross section.

FIG. 8C is a cross sectional view taken along line 8C-8C of FIG. 8B, and illustrating the connector element in a locked position to retain the connector element on the screw.

FIG. 8D is a cross sectional view similar to FIG. 8C, but illustrating the connector element rotated to an unlocked position allowing removal thereof from the screw head.

FIG. 8E is a top view of the screw and a portion of the connector element shown in FIG. 8A, illustrated in the locked position.

### DETAILED DESCRIPTION OF THE ILLUSTRATIVE EMBODIMENTS

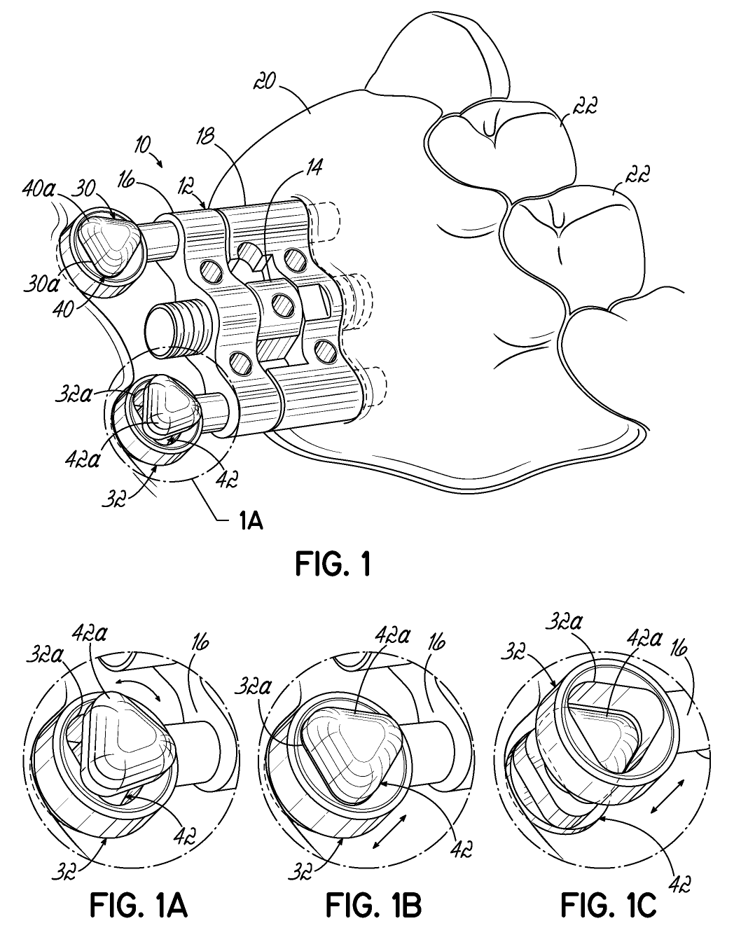

FIGS. 1 and 1A through 1C illustrate an orthodontic appliance in the form of a palatal expansion device 10 constructed in accordance with one illustrative embodiment of the invention. Specifically, a main body portion 12 of the palatal expansion device is generally conventional in structure and includes a screw activation mechanism 14 and a pair of operating components 16, 18. A custom made coupling element 20 secures one side of the device 10 to teeth 22 of the patient. The opposite side of the device 10 includes a pair of eyelets 30, 32. The eyelets 30, 32 are formed with triangular holes 30a, 32a that correspond in shape to triangular heads 40a, 42a of a pair of respective mini-screws 40, 42. Threaded portions of the mini-screws 40, 42 such as shown in embodiments described below are first implanted in the palatal bone or skeletal structure of the patient and each screw head 40a, 42a is turned so that it aligns with the respective holes 30a, 32a of the eyelets 30, 32 as shown for the upper screw head 40a and eyelet hole 30a in FIG. 1 and the lower screw head 42a as shown in FIG. 1B. FIG. 1 illustrates that the lower implant screw 42 has been rotated approximately 60° into a locked position in which the screw head 42a is misaligned with the hole 32a of the eyelet 32 and, therefore, the eyelet is locked against removal. When the upper screw head 40a is rotated in the same manner, both mini-screws 40, 42 will be in locked positions and the expansion device 10 will be retained in place and may then be used to expand the palate of the patient by rotating the activation mechanism 14 in a known manner.

FIGS. 1A through 1C illustrate the successive steps involved in removing the appliance 10. That is, the screw head 42a is rotated approximately 60° from the locked position shown in FIG. 1A to the unlocked position shown in FIG. 1B. At this point, the screw head 42a is aligned with the triangular shaped hole 32a of the eyelet 32. The same procedure is used to align the screw head 40a with the eyelet hole 30a. The appliance 10 may then be moved in a linear fashion directly off of the mini-screws 40, 42 as shown in FIG. 1C. When it is desired to replace the appliance 10 in the patient, the eyelets 30, 32 may simply be inserted over and past the screw heads 40a, 42a and the screw heads 40a, 42a may then be rotated through a partial rotation to the locked position as previously described.

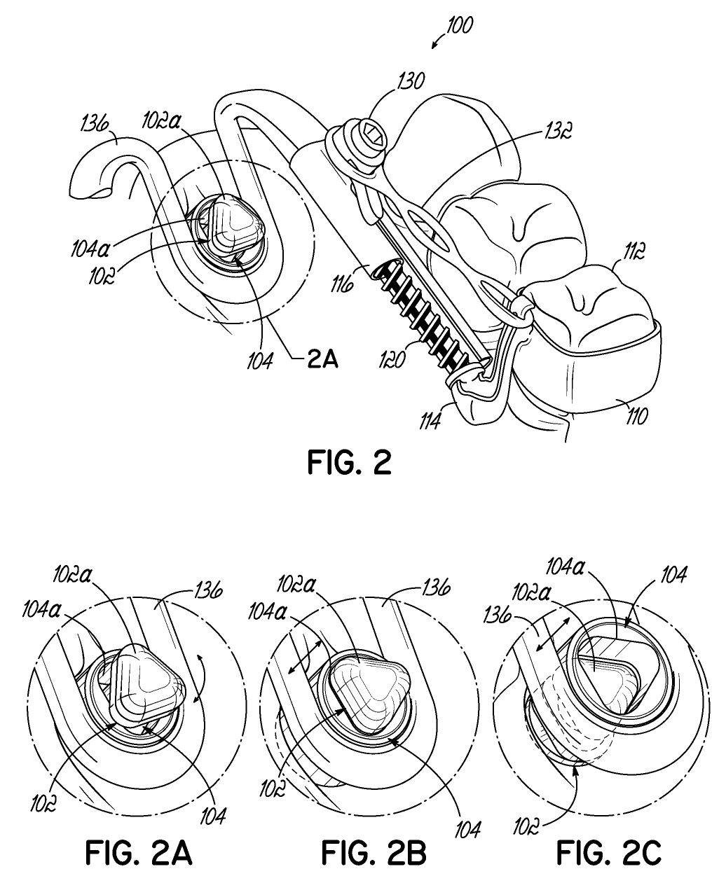

FIGS. 2 and 2A through 2C illustrate a portion of an orthodontic appliance in the form of a molar distalization device 100 that is constructed in a known manner, except for the incorporation of a mini-screw 102 and eyelet 104 having an opening 104a constructed in accordance with an illustrative embodiment of the invention. This mini-screw 102 and attached screw head 102a, as well as the eyelet 104 and its opening 104a are constructed in the manner previously described in connection with FIGS. 1 and 1A through 1C. In this example, approximately one-half of the distalization device 100 is shown and includes a band 110 encircling a molar tooth 112 of the patient and including a connecting element 114 welded thereto. The remaining half of the device 100 may be similarly designed and configured or may take any other suitable configuration. Together, the band 110 and the connecting element 114 comprise one operating component movable relative to another operating component 116 to “distalize” the molar or, in other words, move the molar in a distal direction. In a known manner, a spring 120 is used to apply a bias between the two operating components and a screw adjustment element 130 may be used to apply more or less distalization force. An elastic band 132 may be coupled generally between the screw adjustment element 130 and the band. A mid-section 136 of the appliance or device 100 is welded or otherwise rigidly secured to the eyelet 104. In this manner the central portion of the device 100 may be anchored to the patient's palatal bone structure using the mini-screw 102.

As with the embodiment described in connection with FIGS. 1 and 1A through 1C, the distalization device 100 is applied to the patient by first implanting the mini-screw 102 in the palatal bone structure of the patient, for example, such that the screw head 102a is rotated to an unlocked orientation or position, as shown in FIG. 2B. The device 100 is then installed by moving the eyelet hole 104a into alignment with the screw head 102a, and then over and past the screw head 102a. The screw head 102a is then “locked” relative to the eyelet 104 by a partial rotation, such as a “quarter turn” or, in this example, a partial rotation of approximately 60° as illustrated in FIG. 2. The remaining portions of the device or appliance 100 may then be secured to the patient in a known manner. To remove the device 100, the screw head 102a is partially rotated as shown in the progression of FIGS. 2A and 2B and the device 100 may then be lifted or moved off of the mini-screw as shown in FIG. 2C.

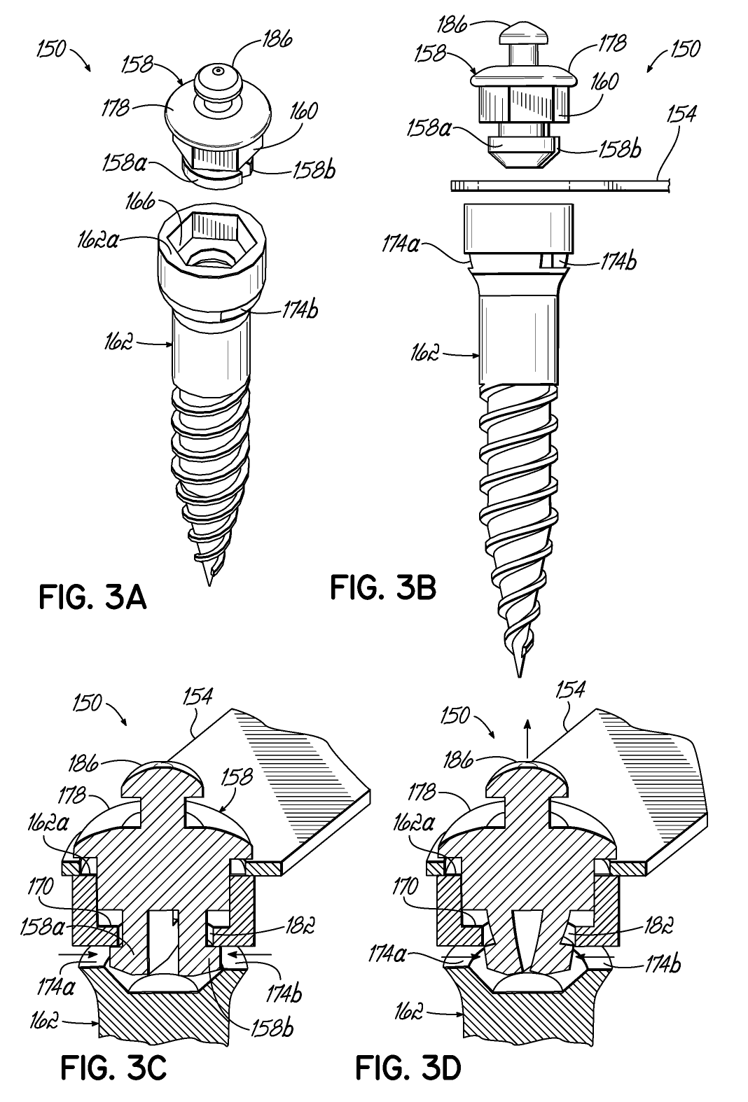

FIGS. 3A, 3B, 3C and 3D illustrate an alternative embodiment of an orthodontic screw 150 for releasable coupling or connection with a connector element 154 of an orthodontic appliance (not shown). It will be appreciated that, with respect to this embodiment as well as those to be described below, the entire orthodontic appliance is not shown as it may be of known or conventional construction and configuration, such as those previously shown. The connector elements shown herein may also be changed in design while still retaining the general features to be discussed herein with regard to the ability to detach the connector element and, therefore, the orthodontic appliance from the patient without removing the threaded portion of the orthodontic screw or screws being used to attach the appliance to skeletal structure the patient. In this embodiment, the head 158, or at least a portion of the head 158, is connected to the threaded body 162 of the screw 150 in a locked but releasable manner. In this regard, the head portion 158 includes two connection arms 158a, 158b that may be resiliently compressed toward one another under a biasing force as shown in FIG. 3D. This allows insertion of a hex portion 160 the screw head portion 158 into a mating hex receptacle 166 at the top of the screw body 162. As the screw head portion 158 is inserted downwardly within the receptacle 166, the arms 158a, 158b will resiliently squeeze or compress together as they pass a flange 170 (FIG. 3C) and, once past the flange 170, the arms 158a, 158b will spring back radially outwardly and be retained in respective slots 174a, 174b of the body 162. In this manner, the connector element 154 of the orthodontic appliance may be retained between an upper flange 178 of the screw head portion 158 and an upper surface 162a of the screw body 162 as shown in FIG. 3C. The slots 174a, 174b may receive a tool (not shown) for squeezing the arms 158a, 158b radially inward as shown in FIG. 3D thereby allow the arms 158a, 158b to pass through the central hole 182 created by the flange 170. Another tool (not shown) may be used to grasp the protrusion 186 at the top of the screw head portion 158 to pull the screw head portion 158 out from the body 162 allowing removal of the connector element 154 and, therefore, an orthodontic appliance associated therewith.

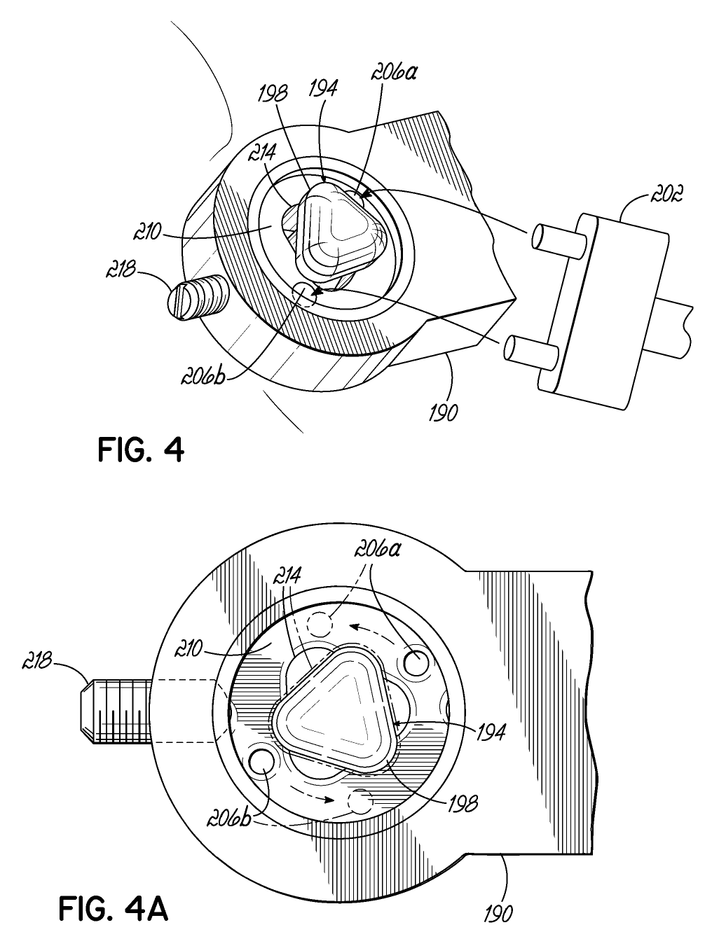

FIGS. 4 and 4A illustrate another alternative embodiment in which a connector element 190 associated with an orthodontic appliance (not shown) may be activated between locked and unlocked positions relative to an orthodontic screw 194 having a screw head 198. In this regard, a tool 202 may be used to engage a pair of holes 206a, 206b or other tool engagement structure associated with a rotatable member 210 of the connector element 190. The rotatable member 210 may be rotated between the locked position shown in FIGS. 4 and 4A in which the triangular shaped head 198 is misaligned with the triangular shaped opening or hole 214 of the rotatable member 210. A set screw 218 is tightened against the rotatable member 210 to further establish the locked position. It will be appreciated that any other suitable locking element may be used in place of the set screw 218. One other possibility, for example, is a spring-loaded plunger element that would selectively engage the rotatable member 210 to prevent rotation. With the set screw 218 loosened, the rotatable member 210 may be rotated to the unlocked position shown in dashed lines of FIG. 4A such that the triangular shaped screw head 198 is aligned with the triangular shaped hole 214. This allows the connector element to be removed from the orthodontic screw 194 while a threaded portion (not shown) of the screw 194 remains implanted.

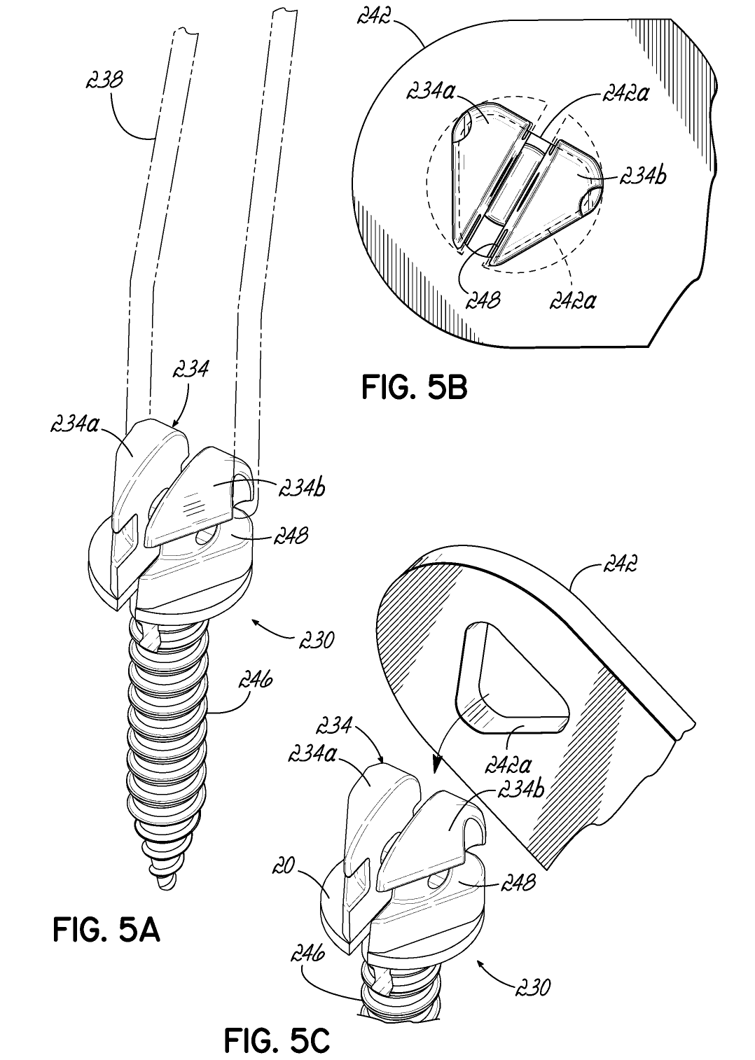

FIGS. 5A, 5B and 5C illustrate another alternative embodiment of an orthodontic screw 230 having a head 234 that may be moved between locked and unlocked positions. In particular, the screw head 234 includes first and second portions 234a, 234b that may be resiliently squeezed or compressed together using a suitable tool 238, for example, to allow removal of a connector element 242 associated with an orthodontic appliance. The connector element 242 may be placed onto the orthodontic screw head 234 and surfaces of the screw head 234 itself may provide a camming action such that, as the triangular shaped hole 242a of the connector element 242 is pushed onto the head 234, the first and second portions 234a, 234b squeeze or compress together until the connector element 242 passes the triangular shaped head 234 and registers with a recess or undercut 248. At this point, the first and second head portions 234a, 234b expand outwardly under a bias and are retained on an opposite side of the connector element 242. In this regard, the dimensions of the triangular shaped screw head 234 in its expanded, normal state are greater than the triangular dimension of the hole 242a in the connector element 242. When removal of the connector element 242 and any associated orthodontic appliance is desired, the tool 238 may be used to squeeze the head portions 234a, 234b together to a smaller dimension allowing the triangular shaped screw head 234 to pass through the triangular shaped hole 242a in the connector element 242. In this manner, the orthodontic appliance may be removed from the patient and replaced, for example, without removing the threaded portion 246 of the screw implant 230 from the skeletal structure of the patient.

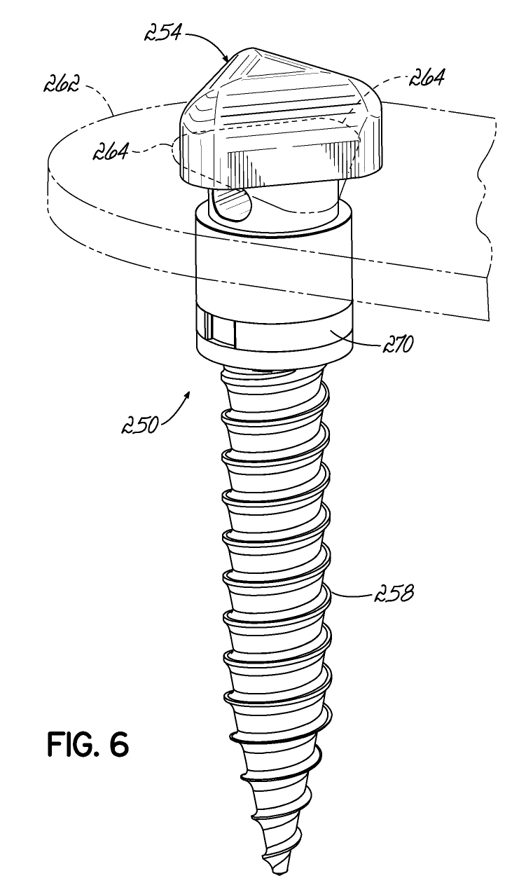

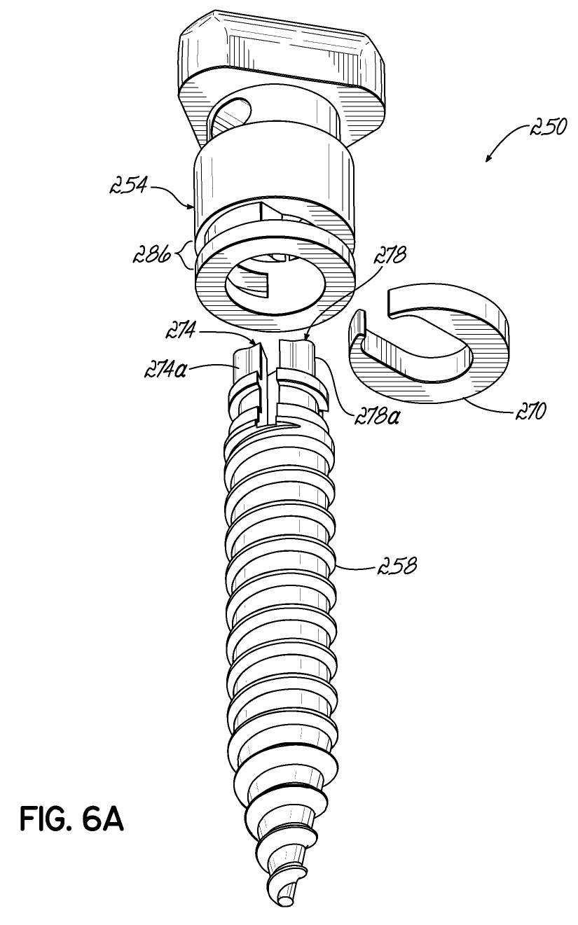

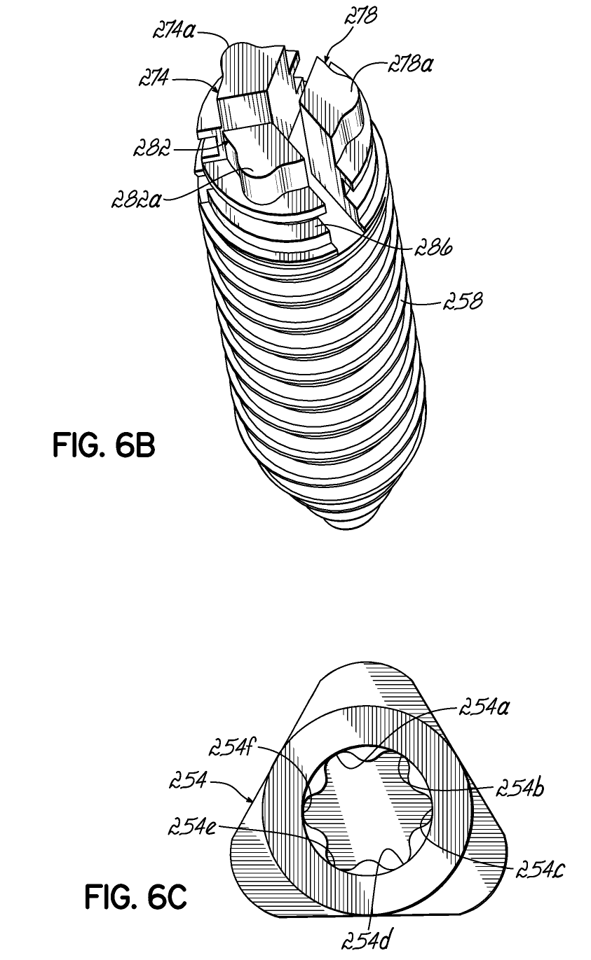

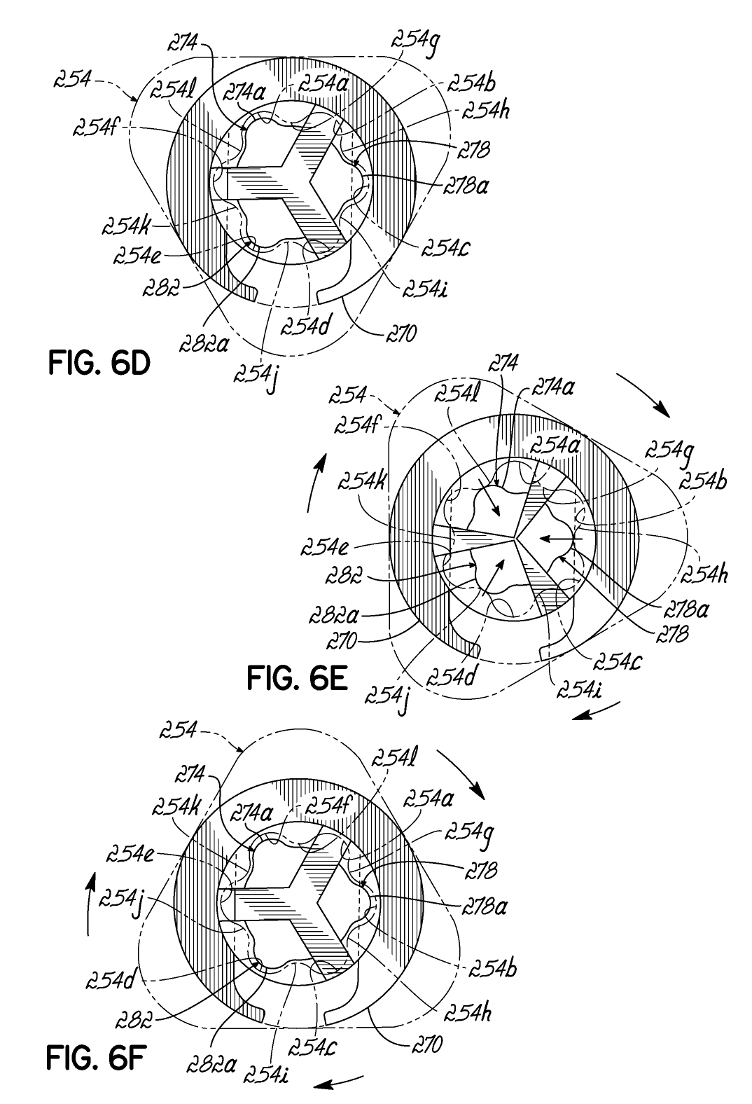

FIGS. 6 and 6A-6F illustrate another embodiment of an orthodontic screw 250 in which the screw head 254 may be rotated relative to the threaded portion 258 of the screw 250 in order to achieve locked and unlocked positions relative to a connector element 262 having a correspondingly shaped hole or eyelet, such as those illustrated in FIGS. 1 and 2. In this embodiment, as shown in FIG. 6A, the screw head 254 may be attached to the threaded portion 258 of the screw 250 by way of a clip 270. At the top of the threaded portion 258, three arms 274, 278, 282 are provided that may be forced radially inward against a bias, for example, provided by the characteristics of the material used to form the threaded body portion 258. For example, this material may be titanium. In top view, as illustrated in FIGS. 6D-6F, the arms 274, 278, 282 have protrusions 274a, 278a, 282a extending radially outward. These three respective protrusions 274a, 278a, 282a may register with respective recesses 254a-f provided within the screw head 254. The attachment of the screw head 254 to the threaded body 258 by way of the clip 270 being received in a recess 286 allows the head 254 to be rotated with respect to the body 258. As the head 254 is rotated, the respective recesses 254a-f rotate with respect to the protrusions 274a, 278a, 282a on the arms 274, 278, 282 allowing the head 254 to snap into any one of six different rotational positions relative to the threaded portion or body 258 and the arms 274, 278, 282. As the head 254 is rotated, the arms 274, 278, 282 resiliently squeeze or compress radially inward as shown in FIG. 6E as each of the protrusions 274a, 278a, 282a passes respective protrusions 254g-l between the recesses 254a-f within the screw head 254. In this manner, the screw head 254 may be rotated between locked and unlocked positions with respect to the threaded body 258 such that, for example, the triangular shaped head 254 respectively aligns and misaligns with a triangular shaped hole in an eyelet (FIGS. 1 and 2). Thus, the head 254 alone may be rotated between a locked position and an unlocked position while the threaded portion 258 of the orthodontic screw 250 does not rotate and remains implanted. When the head 254 is aligned with a correspondingly shaped eyelet, or otherwise moved to an unlocked position, the connector element 262 and associated appliance may be lifted off of the head 254 as previously discussed.

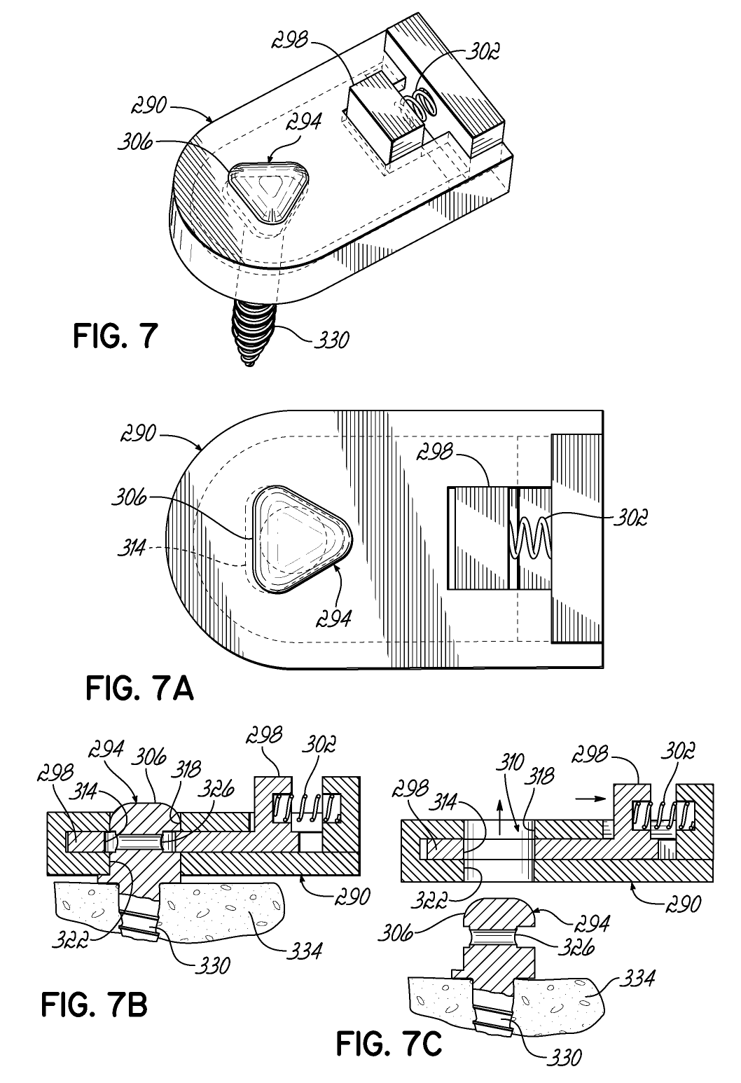

FIGS. 7 and 7A-7C illustrate another alternative embodiment in which a connector element 290 of an orthodontic appliance (not shown) may be activated between locked and unlocked positions to be respectively retained on and released from an orthodontic screw 294. In this regard, a movable locking portion 298 of the connector element 290 is normally biased into a locked position by a spring 302, for example, to retain the head 306 of the screw 294 within an eyelet 310 as shown in FIG. 7B. In this regard, the movable portion 298 includes a hole 314 that, in the locked position, misaligns with respective additional holes 318, 322 in the connector element 290 and engages a recess 326 of the head 306. In this position, shown in FIG. 7B, the connector element 290 may not be lifted from the screw head 306 since the movable locking portion 298 will engage the upper portion of the screw head 306 and prevent disengagement of the connector element 290 from the screw head 306. With the movable locking portion 298 moved to the right, as viewed in FIG. 7C, against the biasing force provided by the spring 302, the respective holes 314, 318, 322 in the connector element 290 align thereby allowing the connector element 290 to be lifted from the screw head 306 while the threaded portion 330 of the screw 294 remains implanted in the skeletal structure 334 of the patient.

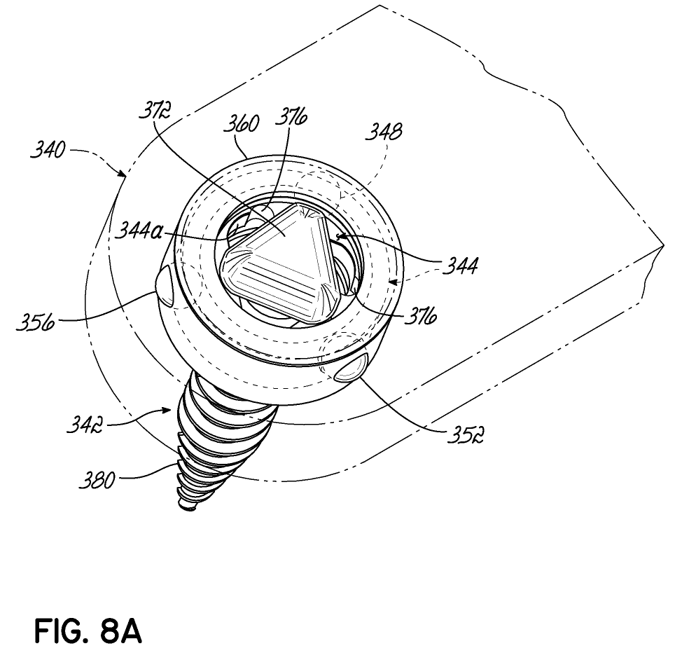

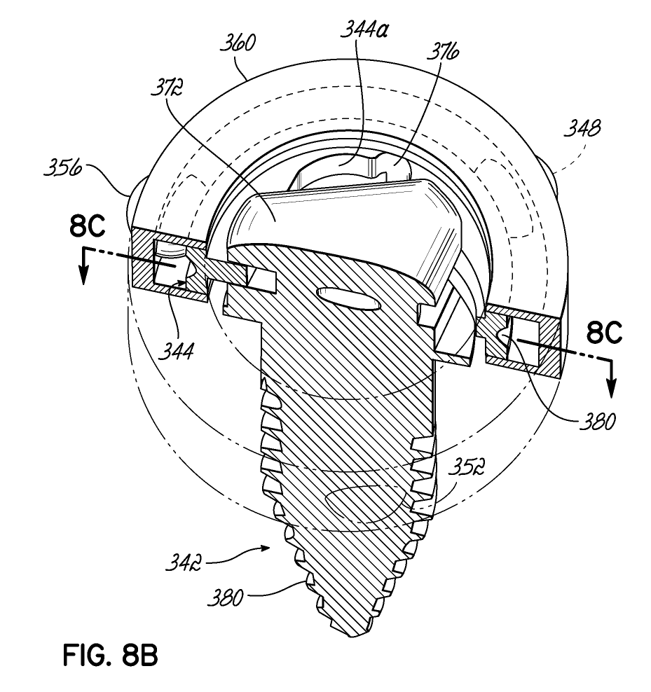

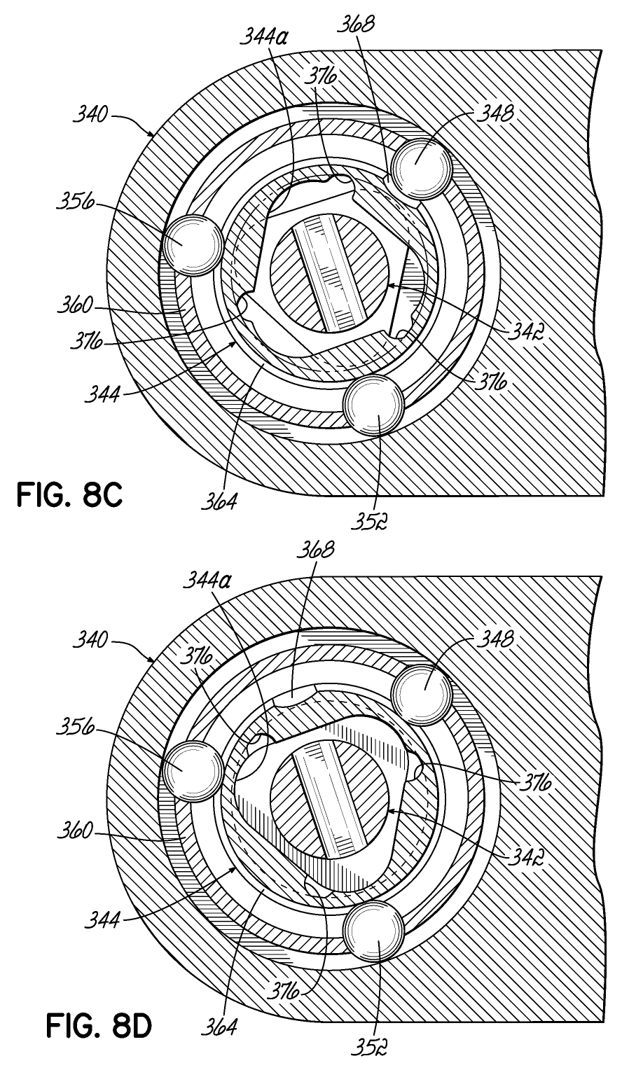

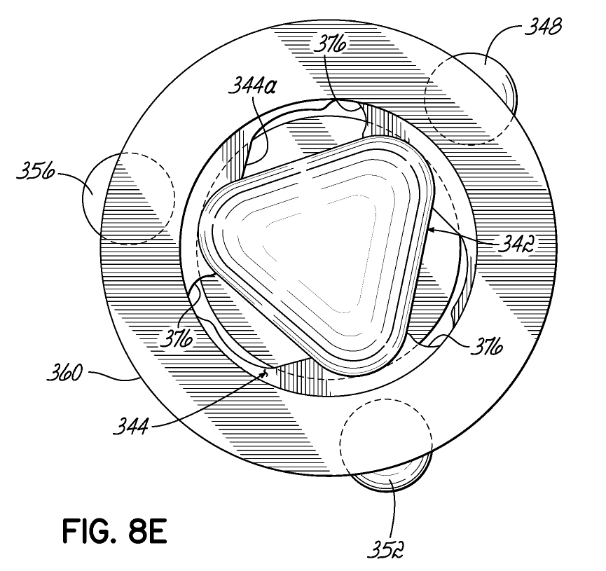

FIGS. 8A-8E illustrate another embodiment similar to the embodiment shown and discussed with regard to FIGS. 4 and 4A. In this embodiment, the connector element 340 includes a rotatable portion 344 that may be engaged by a suitable tool (not shown) in order to rotate the rotatable portion 344 between locked and unlocked positions relative to an orthodontic implant screw 342 shown respectively in FIGS. 8C and 8D. Instead of using a set screw as shown in FIGS. 4 and 4A, spherical balls 348, 352, 356 are used to retain at least the locked position. As shown in FIGS. 8C and 8D, the balls 348, 352, 256 are trapped between two portions of the connector element 340, i.e., the inner rotatable portion 344 and an outer, nonrotatable portion 360. The inner rotatable portion provides a groove 364 within which the balls 348, 352, 356 may freely rotate as the inner portion 344 and its associated triangular hole 344a rotate about the longitudinal axis of the screw 342. The inner portion 344 also includes a locking detent 368 in which one of the balls 348 may reside to fix the position in a locked condition as shown in FIG. 8C. Upon application of suitable rotational force, the recess or detent 368 may be rotated away from the ball 348 into an unlocked position aligning the triangular shaped screw head 372 with the triangular shaped hole 344a of the rotatable portion 344. Rotational force may be applied using a suitable tool (not shown) engaging one or more recesses 376 to rotate the inner portion 344. This allows the connector element 340 and any associated appliance to be lifted or removed off of the screw head 372 while the threaded portion 380 of the screw remains implanted in the skeletal structure of the patient.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. An orthodontic appliance for correcting malocclusions, comprising:
a device including first and second operating components, at least one of the operating components configured to be coupled to at least one tooth of a patient, the operating components being coupled together in a manner allowing controlled movement of at least one of the operating components for purposes of correcting the malocclusion,
a connector element including an eyelet coupled to at least one of the first or second operating components, and
an orthodontic screw including a threaded portion and a head, the head being movable between a locked and unlocked position such that in the locked position the connector element may not be removed from the head and in the unlocked position the connector element may be removed from the head while the threaded portion remains implanted in skeletal structure of a patient.

2. The appliance of claim 1, wherein the first and second operating components form part of a palatal expansion device.

3. The appliance of claim 1, wherein the first and second operating components form part of a molar distalization device.

4. The appliance of claim 1, wherein the eyelet and the head have corresponding geometric shapes.

5. The appliance of claim 4, wherein the corresponding geometric shapes are triangular.

6. The appliance of claim 1, wherein the head may be rotated from the locked position to the unlocked position.

7. The appliance of claim 6, wherein the head may be rotated relative to the threaded portion.

8. The appliance of claim 7, wherein the head and the threaded portion are fixed for rotation together relative to the connector element.

9. The appliance of claim 1, wherein the head is removable from the threaded portion to move the head to the unlocked position.

10. The appliance of claim 9, wherein the head is removably coupled to the threaded portion with a snap fit.

11. The appliance of claim 1, wherein at least one portion of the screw may be moved with respect to another portion during movement of the head between the locked and unlocked portions.

12. The appliance of claim 1, wherein the one portion is moved against a biasing force.

13. An orthodontic appliance for correcting malocclusions, comprising:
a device including first and second operating components, at least one of the operating components configured to be coupled to at least one tooth of a patient, the operating components being coupled together in a manner allowing controlled movement of at least one of the operating components for purposes of correcting the malocclusion,
a connector element including an eyelet coupled to at least one of the first or second operating components, at least a portion of the connector element being movable between locked and unlocked positions, and
an orthodontic screw including a threaded portion and a head, the head being retained in the eyelet in the locked position and removable from the eyelet in the unlocked position while the threaded portion remains implanted in skeletal structure of a patient.

14. The appliance of claim 13, wherein the first and second operating components form part of a palatal expansion device.

15. The appliance of claim 13, wherein the first and second operating components form part of a molar distalization device.

16. The appliance of claim 13, wherein the eyelet and the head have corresponding geometric shapes.

17. The appliance of claim 16, wherein the corresponding geometric shapes are triangular.

18. The appliance of claim 13, wherein at least the portion of the connector element may be rotated from the locked position to the unlocked position.

19. The appliance of claim 13, wherein the connector element includes a biasing structure, and at least the portion of the connector element is movable against a biasing force provided by the biasing structure.

20. The appliance of claim 13, wherein at least the portion of the connector element may be moved in a linear manner from the locked to the unlocked position.

21. A method of attaching an orthodontic appliance to a patient for correcting a malocclusion, comprising:
implanting a threaded portion of at least one orthodontic screw in skeletal structure of the patient,
retaining the orthodontic screw with respect to an eyelet of the orthodontic appliance using a head of the orthodontic screw in a locked position relative to the eyelet, and
moving at least one of the head or the eyelet from the locked position to an unlocked position allowing the eyelet to be removed from the orthodontic screw while the threaded portion remains implanted in the skeletal structure of the patient.

22. The method of claim 21, wherein the orthodontic appliance comprises a palatal expansion device.

23. The method of claim 21, wherein the orthodontic appliance comprises a molar distalization device.

24. The method of claim 21, wherein moving at least one of the head or the eyelet further comprises:
rotating the head and the threaded portion together.

25. The method of claim 21, wherein moving at least one of the head or the eyelet further comprises:
moving at least a portion of the head relative to the threaded portion.

26. The method of claim 25, wherein moving at least one of the head or the eyelet further comprises:
rotating at least a portion of the head relative to the threaded portion.

27. The method of claim 25, wherein moving at least one of the head or the eyelet further comprises:
removing at least a portion of the head from the threaded portion.

28. The method of claim 21, wherein the head and the eyelet have corresponding geometric shapes and moving at least one of the head or the eyelet further comprises aligning the corresponding geometric shapes.

29. The method of claim 21, wherein moving at least one of the head or the eyelet further comprises:
moving at least a portion of the connecting element.

30. The method of claim 29, wherein moving at least a portion of the connecting element further comprises:
rotating at least a portion of the connecting element.

31. The method of claim 21, wherein moving at least one of the head or the eyelet further comprises:
moving at least a portion of the connecting element in a linear manner.

32. The method of claim 21, wherein moving at least one of the head or the eyelet further comprises:
moving at least one of the head or the eyelet against a biasing force.
